(19) United States
(12) Patent Application Publication
(10) Pub. No.: US 2006/0213957 A1
(43) Pub. Date: Sep. 28, 2006

(54) Conductive trace formation via wicking action

(76) Inventors: Cary G. Addington, Albany, OR (US); Leo C. Clarke, Albany, OR (US); Chris C. Aschoff, Corvallis, OR (US); Barry C. Snyder, Bend, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/089,977

(22) Filed: Mar. 26, 2005

(51) Int. Cl. B23K 31/02; B23K 1/20

(52) U.S. Cl. 228/208; 228/203

(57) ABSTRACT

A wetting zone is defined within a substrate. A conductive material is applied to the wetting zone. A conductive trace is at least partially formed within the wetting zone from the conductive material flowing throughout the wetting zone by wicking action.

### BACKGROUND

Conductive traces are a mainstay within electronic devices. Conductive traces connect different electrical components of such devices. They also connect electrical components of electronic devices to bonding pads or contacts of the devices. The bonding pads or contacts are then connected to other electronic devices, so that two or more electronic devices can be interconnected.

On small electronic devices, such as semiconductor devices, inkjet printheads, and other types of electronic devices, the conductive traces are typically formed on two-dimensional planes of the devices. Thus, a given conductive trace can be formed to connect two electrical components on the same two-dimensional plane of an electronic device. However, as electronic devices have become more complex, their electrical components may need to be connected in three dimensions, including a dimension perpendicular to the primary two-dimensional plane of an electronic device.

### BRIEF DESCRIPTION OF THE DRAWINGS

The drawings referenced herein form a part of the specification. Features shown in the drawing are meant as illustrative of only some embodiments of the invention, and not of all embodiments of the invention.

FIG. 1 is a flowchart of a method for forming a conductive trace via wicking action, according to an embodiment of the invention.

FIGS. 2A and 2B are diagrams of electronic devices, each having a substrate within which a wetting, wicking, or hydrophilic zone has been defined, according to different embodiments of the invention.

FIGS. 3A and 3B are diagrams of electronic devices, each having a substrate having a wetting, wicking, or hydrophilic zone within which a conductive trace has been formed via wicking action or capillary force, according to different embodiments of the invention.

FIGS. 3C and 3D are top-view and front-view diagrams, respectively of an electronic device having a substrate having a wetting, wicking, or hydrophilic zone within which a conductive trace has been formed via wicking action or capillary force, according to another embodiment of the invention.

FIG. 4 is a flowchart of a method for forming a conductive trace via wicking action, according to another embodiment of the invention.

FIG. 5 is a diagram of the conductive seeds left or formed as a result of wicking action of a conductive seed material throughout a wicking zone to at least partially form a conductive trace, according to an embodiment of the invention.

FIG. 6 is a diagram of additional conductive material electroless-plating the conductive seeds of FIG. 5 to further form the conductive trace within the wicking zone, according to an embodiment of the invention.

FIG. 7 is a diagram of further conductive material electroplated onto the additional conductive material electroless-plating the conductive seeds in FIG. 6, to more fully form the conductive trace within the wicking zone, according to an embodiment of the invention.

### DETAILED DESCRIPTION OF THE DRAWINGS

In the following detailed description of exemplary embodiments of the invention, reference is made to the accompanying drawings that form a part thereof, and in which is shown by way of illustration specific exemplary embodiments in which the invention may be practiced. These embodiments are described in sufficient detail to enable those skilled in the art to practice the invention. Other embodiments may be utilized, and logical, mechanical, electrical, electro-optical, software/firmware and other changes may be made without departing from the spirit or scope of the present invention. The following detailed description is, therefore, not to be taken in a limiting sense, and the scope of the present invention is defined only by the appended claims.

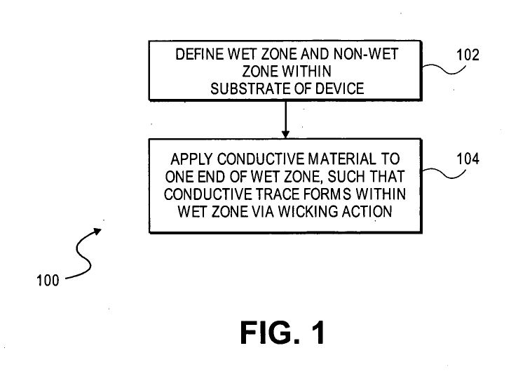

FIG. 1 shows a method 100 for forming a conductive trace within a substrate of an electronic device via wicking action or capillary force, according to an embodiment of the invention. The method 100 may thus be performed to at least partially fabricate such an electronic device. First, a wetting zone is defined within the substrate of the electronic device, as well as a non-wetting zone (102). The wetting zone may also be referred to as a wicking zone, or a hydrophilic zone.

The wetting zone is a portion of the substrate on, in, through, or within which a liquid or semi-liquid conductive material will flow via wicking action or capillary force. For example, the wetting zone may be defined as a groove or trough within the substrate created by laser ablation. The laser ablation process inherently renders the sides of the groove or trough as roughened compared to other surfaces of the substrate. These roughened surfaces form the wetting zone, because a liquid or semi-liquid material applied to one end of the wetting zone will flow to the other end of the wetting zone via wicking action or capillary force. By comparison, the other surfaces of the substrate, which are relatively smoother than the wetting zone, will not have the material flow therein or thereover. These other surfaces are referred to as non-wetting, non-wicking, or hydrophobic zones, and are inherently defined in one embodiment by defining the wetting zones explicitly.

The wetting zone itself is sufficient to provide for capillary force or wicking action to cause a liquid or semi-liquid material applied to one end of the wetting zone to flow to the other end thereof. As such, the resultant capillary force may come about due to the geometry of the wicking zone, such as where the wicking zone is a tube or a channel; due to the surface roughness of the wicking zone; or, a combination of the geometry of the wicking zone and the surface roughness of the wicking zone. In this way, a smooth-sided tube or channel may provide for capillary force or wicking action, as well as a roughened path, which is in actuality a series of microchannels, that is not part of a channel or a tube may provide for capillary force or wicking action.

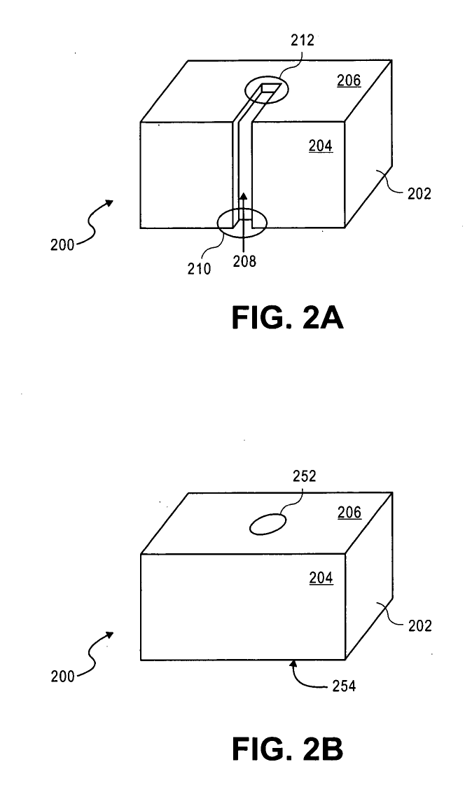

FIGS. 2A and 2B show examples of wetting zones defined within a substrate of an electronic device, according to varying embodiments of the invention. Both FIGS. 2A and 2B depict an electronic device 200 including a substrate 202. The electronic device 200 may be a semiconductor device, an inkjet printhead (where the substrate 202 is an inkjet printhead substrate), or another type of electronic device. Whereas just the substrate 202 of the electronic device 200 is depicted in FIGS. 2A and 2B, this is for illustrative clarity only, and typically the electronic device 200 will have more layers than the substrate 202. The substrate 202 may be silicon, glass, Mylar®, ceramic, plastic, or another type of substrate. The substrate 202 may a flexible or a non-flexible substrate. That is, at least some embodiments are amenable to formation of a conductive trace on the substrate 202 even when it is a flexible substrate. The substrate 202 has a front surface 204 and a top surface 206.

In FIG. 2A, a trench or groove 208 has been laser ablated within the front surface 204, from a first end 210, and partially onto the top surface 206, to a second end 212. The groove 208 is the wetting zone. The sides of the groove 208, due to laser ablation, are rougher compared to other surfaces of the substrate 202. For instance, the surface energies and/or the wetted contact angles may be designed to define and/or control the zones or the edges such that hydrophilic and hydrophobic properties desirably result. A surface that is hydrophilic attracts liquid, and therefore is amenable to wicking action or capillary force causing the liquid to spread over the surface, whereas a surface that is hydrophobic does not attract, and can repel, liquid, and thus does not have liquid spread thereover by wicking action or capillary force.

The groove 208 extends across three dimensions. The primary two-dimensional plane of the substrate 202 may be the plane of the top surface 206 thereof. Thus, the groove 208 extends across this plane, and then perpendicular into or over the plane of the front surface 204 of the substrate 202. The groove 208 is completely exposed along its entire path. Furthermore, it can be said that the groove 208 has a path relative to the substrate 202 along three dimensions.

In FIG. 2B, a via or through-hole 252 has been formed from the top surface 206 of the substrate 202 through to a bottom surface 254 of the substrate 202. The sides of the through-hole 252 are again roughened compared to other surfaces of the substrate 202. Unlike the groove 208 of FIG. 2A, the through-hole 252 is not completely exposed along its entire path, but rather just at the top surface 206 and at the bottom surface 254 of the substrate 202 of the electronic device 200.

Different types of processes can be performed to define the wetting, hydrophilic, or wicking zone within the substrate of an electronic device. Laser ablation is one type of process that has already been noted. Other processes include photolithography and etching, as well as plastic-injection molding of paths. Another process involves rolling a roller along the substrate of an electronic device, to cut or form grooves within the substrate.

In each of these processes, the wetting, hydrophilic, or wicking zone is defined in one embodiment by having the surfaces formed as a result of performing the process being roughened compared to other surfaces of the substrate. In another embodiment, the wetting, hydrophilic, or wicking zone is defined by the resultant geometries and shapes and dimensions of the surfaces produced, including, but not be limited to, channels, tubes, parallel-opposing ribs, and right-angle trenches formed by two orthogonal intersecting planes. Such roughened surfaces, or geometries, allow a liquid or semi-liquid conductive material to flow, or wick, through the zone via wicking action or capillary force. The material does not flow or wick through or onto other surfaces of the substrate, which are referred to as non-wetting, hydrophobic, or non-wicking zones.

Referring back to FIG. 1, a conductive material is applied to one end of the wetting zone that has been defined, such that a conductive trace forms within the wetting zone via wicking action or capillary force (104). The conductive material is applied to one end of the wetting zone in a liquid, semi-liquid, molten, or semi-molten state. By wicking action or capillary force, the conductive material naturally flows throughout the wetting zone in one embodiment of the invention. In this way, a conductive trace is formed.

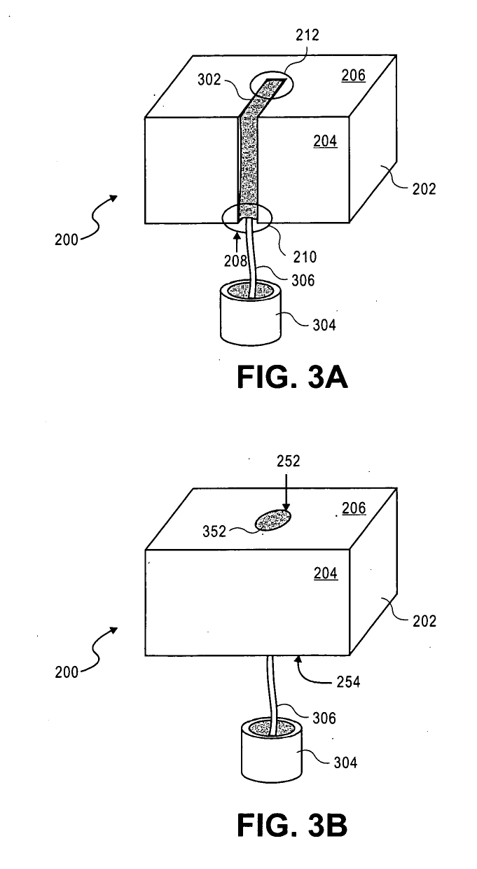

FIGS. 3A and 3B show examples of conductive traces formed within wetting zones via wicking action or capillary force, according to varying embodiments of the invention. FIG. 3A corresponds to the groove 208 formed as the wetting zone in FIG. 2A. In FIG. 3A, a conductive material 304 is applied via a capillary tube 306 to one end 210 of the groove 208. By wicking action or capillary force, the conductive material 304 flows throughout the groove 208, to the other end 212 of the groove 208, resulting in formation of a conductive trace 302 within the groove 208.

FIG. 3B corresponds to the through-hole 252 formed as the wetting zone in FIG. 2B. In FIG. 3B, the conductive material 304 is again applied via the capillary tube 306 to an end of the through-hole 252, at the opening of the through-hole 252 at the bottom surface 254 of the substrate 202. By wicking action or capillary force, the conductive material 304 flows through the through-hole 252, to the other opening of the through-hole 252 at the top surface 206 of the substrate 202. This results in formation of a conductive trace 352 within the through-hole 252.

The application of the conductive material 304 to the wetting zones in FIGS. 3A and 3B is depicted via using a capillary tube 306 fluidly coupled to a supply of the conductive material 304. Other approaches can also be employed to apply the conductive material to an end of a wetting zone. For example, a portion of the substrate encompassing the end of the wetting zone can be submerged or dipped into the conductive material. The conductive material may also be carefully poured onto the desired end of the wetting zone, and so on.

The utilization of wicking action or capillary force to cause the conductive material to form a conductive trace throughout the wetting zone is advantageous because it lends itself to different topologies of conductive traces. For instance, in FIG. 3A the conductive trace 302 exists in three dimensions relative to the substrate 202, whereas in FIG. 3B the conductive trace 352 is present within a through-hole 252. In other embodiments, the substrate may have a spherical, hemispherical, or otherwise round shape where the wetting zone is defined, such that a conductive trace can still be formed within such a wetting zone via wicking action or capillary force.

The conductive material used to form the conductive trace via wicking action or capillary force may be copper, aluminum or an aluminum alloy, a noble metal, or another type of conductive material. In at least some embodiments, the conductive material is not a solder-type material. This is because the conductive trace is intended to be the primary conduit or path over which electricity travels, where such a conduit or path may extend for relatively long distances within the electronic device. By comparison, solder-type conductive material is intended for very short distances, to easily bridge the gap between a conductive trace and an electrical component or another conductive trace or wire. Solder-type conductive material is useful for such short gap bridges, because it can be transformed into its molten or semi-molten state very quickly with a short, local application of heat, without affecting nearby conductive traces or electrical components. Furthermore, solder-type conductive material is not suitable for use in forming bonding pads or other electrical interconnection points, and indeed is instead typically used to bond an external wire or conductor to such bonding pads.

By comparison, non-solder-type conductive material, such as copper, can, in some embodiments, not be useful for short gap bridges, because it requires relatively long exposure to high temperatures to heat, which can also melt nearby conductive traces and damage nearby electrical components. Solder-type conductive material is not intended to be the primary conduit or path over which electricity travels. Solder-type conductive material is not intended for long conduits or paths, because solder has undesirable characteristics. It is brittle, can melt more easily than other types of conductors, and can be thermally disadvantageous, returning to a semi-molten state more quickly than other types of conductors. That is, embodiments of the invention, by employing non-solder-type conductive material, are suitable for forming long-length conductive traces, whereas non-solder-type conductive material is not suitable for forming long-length conductive traces, but only relatively or very short conduction paths. Furthermore, embodiments of the invention can be employed to form bonding pads or other types of electrical interconnection points, as is described in more detail later in the detailed description in reference to FIGS. 3C and 3D, by utilizing non-solder-type conductive material, whereas solder-type conductive material, as has been described, is not suitable for forming such pads or points.

The wicking action by which the conductive material forms a conductive trace via capillary force in at least some embodiments of the invention does not have to occur within a vacuum or partial vacuum. For example, in FIG. 3B, the through-hole 252 is sufficient enough of a wetting, hydrophilic, or wicking zone, by virtue, for instance, of its roughened surfaces, or the diameter of the through-hole, or other geometric properties, that the conductive material applied at the bottom end of the through-hole 252 naturally wicks throughout the through-hole 252 without having to subject the top part of the through-hole 252 to a partial or complete vacuum. Furthermore, as can be appreciated by those of ordinary skill within the art, subjecting the groove 208 of FIG. 3A to a vacuum or partial vacuum to aid the wicking process would not work, since the groove 208 is completely exposed along its entire path over the substrate 202.

The utilization of wicking action or capillary force to form a conductive trace within the wetting, hydrophilic, or wicking zone is an additive process. That is, conductive material is applied to the substrate just where a conductive trace is to be formed. By comparison, in more conventional subtractive processes, conductive material is applied over a large portion of the substrate, and then is partially removed to form the desired conductive trace. In an additive process, none of or nearly no conductive material is removed to form the conductive trace.

FIGS. 3C and 3D show the top view of the top surface 206 of the electronic device 200 and the front view of the front surface 204 of the electronic device 200, respectively, in which a conductive trace 372 has been formed within a trench or groove 378, according to another embodiment of the invention. Conductive material is applied at the bottom end of the groove 378. By wicking action or capillary force, the conductive material flows throughout the groove 378, to the other end 374 of the groove 378, resulting in formation of the conductive trace 372.

The conductive material in the embodiment of FIGS. 3C and 3D may be applied as an enclosed pool or reservoir, such that the conductive material is poured into the groove 378 at the bottom end 376. As depicted in FIGS. 3C and 3D, the ends 376 and 374 of the groove 378 are larger in size than the rest of the groove 378, which with respect to the bottom end 376, facilitates application of the conductive material as an enclosed pool or reservoir. Thereafter, the ends 376 and 374 of the groove 378 can function as bond or bonding pads, or as other termination points. Such other termination points can be considered as zones for electrical joints and other types of interconnection points. While the end 376 has been described as the capillary starting point, in another embodiment, the end 374 may be the capillary starting point or well at which conductive material is initially deposited or otherwise applied. Indeed, in other embodiments of the invention, the capillary starting point may be at a point within the wicking zone that has been defined other than at an end of the wicking zone.

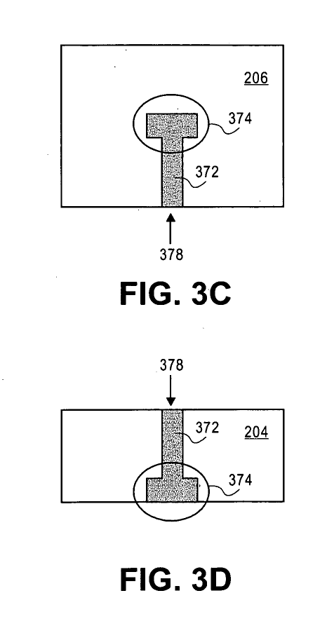

FIG. 4 shows a method 400 for forming a conductive trace via wicking action or capillary force, according to another embodiment of the invention. The method 400 is consistent with but more detailed than the method 100 of FIG. 1. The method 400 may thus also be performed to at least partially fabricate an electronic device having a substrate within which a conductive trace is formed within a wicking zone thereof.

First, the wicking, hydrophilic, or wetting zone is defined within the substrate of the electronic device (402). As in 102 of the method 100 of FIG. 1, such zone definition may be accomplished in one or more different ways. Roughened surfaces on the substrate may be created that are conducive to conductive material flow via capillary flow. A groove or a through-hole may be created by laser ablation as the wicking zone. Photolithography may be employed to form the wicking zone within the substrate. A groove may be roller-cut within the substrate to form the wicking zone, or the roller may form the groove by displacement. A groove may also be etched within the substrate to form the wicking zone.

Next, a conductive seed material is applied to one end of the wicking zone (404). The conductive seed material wicks throughout the wicking zone via capillary force, to form or leave conductive seeds of this conductive seed material throughout the wicking zone. Such wicking action at least partially forms the desired conductive trace in one embodiment of the invention. The application of the conductive seed material to one end of the wicking zone may be accomplished, as has been described in relation to conductive material more generally with reference to FIGS. 3A and 3B, by submerging or dipping this end of the zone into the conductive seed material, by using capillary tubes, and so on.

For example, in different embodiments of the invention, other approaches for applying the conductive seed material include lowering the device into a drop of a solution containing the conductive seed material, or by using a needle to dispense the conductive seed material at an end of the wicking zone or at another capillary starting point or starting well. In another embodiment, the edge of the device may be dipped into a bath of the conductive seed material. Thus, embodiments of the invention are not limited to a particular manner by which the conductive seed material is applied.

In one embodiment, an attractant action may be performed at the other end of the wicking zone to attract the conductive seed material to flow throughout the wicking zone (406). Such an attractant action serves to promote or accelerate the wicking process, and ensures that a solution rich in seed material is deposited along the entire length of even a very long capillary path. For example, with reference to FIG. 3A, the conductive material 304 may be the conductive seed material applied to the end 210 of the wicking zone via a capillary tube 306. At the other end 212 of the wicking zone, several strands of absorptive fibers may be placed into the wicking zone. Once the conductive seed material first contacts such absorptive fibers, the fibers accelerate the wicking process by pulling the conductive seed material from the end 210 of the wicking zone to the end 212 of the wicking zone, to ensure that the conductive seed material is spread throughout the wicking zone.

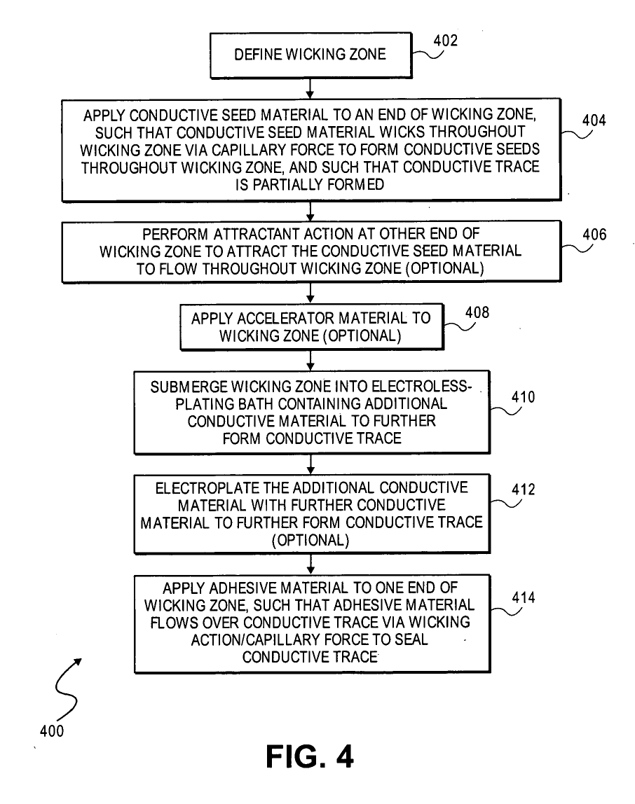

FIG. 5 shows a front view of the electronic device 200 of FIG. 2A after the conductive seed material has wicked throughout the wicking zone and has formed or left conductive seeds throughout the wicking zone, according to an embodiment of the invention. The groove 208 within the substrate 202 shown in the front view of the electronic device 200 is the wicking zone in FIG. 5. The front surface 204 of the substrate 202 is in full view in FIG. 5, and the top surface 206 is also indicated in FIG. 5. Conductive seeds 502 have been formed or have been left throughout the wicking zone after application of the conductive seed material at the end 210 of the wicking zone, to at least partially form or define a conductive trace within the wicking zone.

The conductive seed material is thus a type of conductive material. The conductive seed material may be a conductive material disposed within a colloidal suspension, such as a colloidal suspension palladium mixture. The base solvent or other material is that which wicks throughout the wicking zone via capillary force. The conductive material disposed within this base solvent or other material is then deposited along the wicking zone during wicking of the base solvent material or other material. The conductive seed material may be a commercially available Cataposit material, or another type of conductive seed material, as can be appreciated by those of ordinary skill within the art. The conductive seed material is in a liquid, semi-liquid, molten, or semi-molten state.

Referring back to FIG. 4, an accelerator material may then be applied to the wicking zone (408). The accelerator material is to accelerate subsequent electroless-plating of the conductive seeds deposited to further form the conductive trace. The accelerator material may be applied by submerging the wicking zone within a bath of the accelerator material. In one embodiment, the accelerator material may be Shipley Accelerator, available from Shipley Company, LLC, of Marlborough, Mass., and which is a chemical composition of sulfuric acid, fluoboric acid, and water.

Thereafter, the wicking zone is submerged into an electroless-plating bath containing additional conductive material to further form the conductive trace (410). That is, additional conductive material is applied to the conductive seeds throughout the wicking zone to further form the conductive trace. This conductive material may be copper, aluminum or aluminum alloys, noble metals, or other types of conductive material. The entire device 200 may be placed in an electroless-plating bath, because the electroless-plating material will plate substantially only the seed material. Once this additional conductive material has been applied to a desired thickness, the device 200 can then be rinsed, such that substantially just the seed traces are plated.

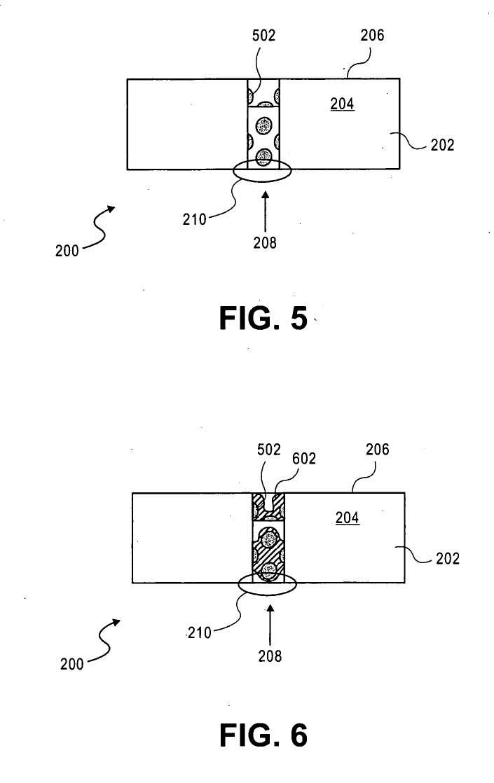

FIG. 6 shows a front view of the electronic device 200 of FIG. 5 after the electroless-plating of the additional conductive material onto the conductive seeds 502 that have been formed throughout the wicking zone, according to an embodiment of the invention. The groove 208 within the substrate 202 shown in the front view of the electronic device 200 is the wicking zone in FIG. 6. The front surface 204 of the substrate 202 is in full view in FIG. 6, and the top surface 206 is also denoted in FIG. 6. Additional conductive material 602 has been electroless-plated onto the conductive seeds 502 to further form or define the conductive trace within the wicking zone.

Referring back to FIG. 4, further conductive material may optionally be electroplated onto the additional conductive material electroless-plated onto the conductive seeds, to more fully and desirably completely form the conductive trace (412). The electroplated conductive material may be the same or a different conductive material than the electroless-plated conductive material in 410. Finally, an adhesive material may be applied to one end of the wicking zone, so that the adhesive material flows over the conductive trace that has been formed, via wicking action or capillary force, to seal the conductive trace (414). Application of adhesive material to seal the conductive trace is accomplished similarly to that of the conductive material in FIGS. 3A and 3B. Alternatively, the sealant may be a needle-dispensed adhesive, a laminate layer applied over the traces, or another type of sealant, as can be appreciated by those of ordinary skill within the art.

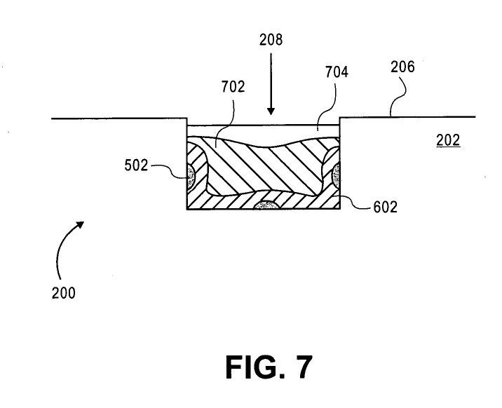

FIG. 7 shows a front view of just the portion of the groove 208 of the electronic device of FIG. 6 that is within the top surface 206 thereof, on which further conductive material has been electroplated onto the electroless-plated conductive material 602, according to an embodiment of the invention. That is, just the portion of the groove 208 within the substrate 202 that is within the top surface 206 is depicted in FIG. 7 for illustrative clarity and simplicity. The portion of the groove 208 within the substrate 202 that is within the front surface 204 is by comparison not depicted in FIG. 7.

The conductive material 602 electroless-plated to the conductive seeds 502 are again depicted in FIG. 7. Further conductive material 702 is electroplated onto the conductive material 602 to more fully define the conductive trace within the groove 208, and thus within the wicking zone. Finally, an adhesive 704 has been applied to one end of the wicking zone, such that it flows over the conductive material 702, and thus over the conductive trace, via wicking action or capillary force, to seal the conductive trace.

The approach to conductive trace formation described in relation to the method 400 of FIG. 4, and as illustrated in FIGS. 5, 6, and 7, involves the formation or depositing of conductive seeds from a conductive seed material that wicks throughout the wicking, hydrophilic, or wetting zone by capillary force or wicking action. The conductive seeds at least partially form the desired conductive trace within this zone. Thereafter, additional and further conductive material can be applied to the conductive seeds to better or more fully form the conductive trace.

The method 400 describes one manner by which such additional and further conductive material can be applied to the conductive seeds. For instance, additional conductive material can be applied by submerging the wicking zone within an electroless-plating bath, and then further conductive material can also optionally be applied by electroplating the electroless-plated conductive material. However, other embodiments of the invention may employ different approaches to further define the conductive trace by applying additional and/or further conductive material to the conductive seeds formed or deposited throughout the wicking zone by capillary force or wicking action.

Therefore, it is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. It is thus manifestly intended that this invention be limited only by the claims and equivalents thereof.

We claim:

1. A method comprising:
defining a wetting zone within a substrate; and,
applying a non-solder conductive material to the wetting zone, such that a conductive trace is at least partially formed within the wetting zone from the conductive material flowing throughout the wetting zone by wicking action, without subjecting the non-solder conductive material to a vacuum.

2. The method of claim 1, wherein defining the wetting zone inherently comprises defining other parts of the substrate as non-wetting zones, such that the conductive material wicks only into the wetting zone via capillary force and not into the non-wetting zones.

3. The method of claim 1, wherein defining the wetting zone comprises creating one or more roughened surfaces on the substrate that are conducive to flow of the conductive material via capillary force.

4. The method of claim 1, wherein defining the wetting zone comprises creating one or more shapes on the substrate that are conducive to flow of the conductive material via capillary force.

5. The method of claim 4, wherein the one or more shapes comprise one or more of: one or more channels, one or more tubes, one or more parallel-opposing ribs, and one or more right-angle trenches, the right-angle trenches formed by orthogonal, intersecting planes.

6. The method of claim 1, wherein defining the wetting zone comprises laser-ablating one of a groove within the substrate.

7. The method of claim 1, wherein defining the wetting zone comprises employing photolithography to define the wetting zone.

8. The method of claim 1, wherein defining the wetting zone comprises roller-cutting a groove within the substrate.

9. The method of claim 1, wherein defining the wetting zone comprises etching a groove within the substrate.

10. The method of claim 1, wherein defining the wetting zone comprises plastic-injection molding of a path within the substrate.

11. The method of claim 1, wherein defining the wetting zone comprises defining a path relative to the substrate within three dimensions.

12. The method of claim 1, wherein applying the conductive material to the one of the ends of the wetting zone comprises dipping the substrate into the conductive material at the one of the ends of the wetting zone.

13. The method of claim 1, wherein applying the conductive material to the one of the ends of the wetting zone comprises:
applying a seed material to the wetting zone, such that seeds of the seed material form throughout the wetting zone to initially form the conductive trace; and,
plating the seeds of the seed material with a second conductive material to further form the conductive trace.

14. The method of claim 13, wherein plating the seeds of the seed material with the second conductive material comprises submerging at least the wetting zone of the substrate within an electroless-plating bath containing the second conductive material.

15. The method of claim 14, further comprising electroplating the second conductive material with a third conductive material to further form the conductive trace.

16. The method of claim 15, wherein the third conductive material is identical in chemical composition to the second conductive material.

17. The method of claim 13, further comprising applying an accelerator material to the wetting zone prior to plating the seeds of the seed material with the second conductive material.

18. The method of claim 1, further comprising performing an attractant action to attract the conductive material applied to the wetting zone by promoting the wicking action of the conductive material.

19. The method of claim 1, further comprising sealing the conductive trace.

20. The method of claim 19, wherein sealing the conductive trace comprises applying an adhesive material to the wetting zone, such that the adhesive material flows by wicking action over the conductive trace to seal the conductive trace.

21. A device having a conductive trace, formed at least in part by a method comprising:
defining a wicking zone within a substrate of the conductive trace;
applying a conductive seed material to an end of the wicking zone, such that the conductive seed material wicks throughout the wicking zone via capillary force and forms conductive seeds throughout the wicking zone; and,
applying a conductive material to the conductive seeds throughout the wicking zone to form a conductive trace within the wicking zone.

22. The device of claim 21, wherein defining the wicking zone comprises at least one of:
creating one or more roughened surfaces on the substrate that are conducive to material flow via capillary force;
laser-ablating one of a groove and a through-hole within the substrate as the wicking zone;
employing photolithography to form the wicking zone within the substrate;
roller-cutting a groove within the substrate as the wicking zone; and,
etching a groove within the substrate as the wicking zone.

23. The device of claim 21, wherein applying the conductive seed material to the end of the wicking zone comprises dipping the substrate into the conductive seed material at the end of the wicking zone.

24. The device of claim 21, wherein applying the conductive seed material to the end of the wicking zone comprises using a capillary tube leading to a supply of the conductive seed material.

25. The device of claim 21, wherein applying the conductive material to the conductive seeds throughout the wicking zone comprises submerging at least the wicking zone of the substrate within an electroless-plating bath containing the conductive material.

26. The device of claim 25, further comprising electroplating the conductive material with another conductive material to more fully form the conductive trace within the wicking zone.

27. The device of claim 21, further comprising applying an accelerator material to the wicking zone prior to applying the conductive material to the conductive seeds.

28. The device of claim 21, further comprising applying an adhesive material to one of the ends of the wetting zone, such that the adhesive material flows over the conductive trace that has been formed by wicking action to seal the conductive trace.

29. A device comprising:
a substrate within which a hydrophilic zone is defined; and,
a non-solder conductive material applied to the hydrophilic zone via wicking action without subjection to a vacuum, to at least partially define a conductive trace within the hydrophilic zone.

30. The device of claim 29, wherein the substrate comprises one of a flexible and a non-flexible substrate.

31. The device of claim 29, wherein the substrate has a round shape where at least a portion of the hydrophilic zone is defined therein.

32. The device of claim 29, wherein the hydrophilic zone is defined as one or more grooves having roughened edges.

33. The device of claim 29, wherein the hydrophilic zone is defined as at least one or more via holes having roughened edges.

34. The device of claim 29, wherein the conductive material comprises a conductive seed material forming conductive seeds throughout the hydrophilic zone via the wicking action.

35. The device of claim 34, wherein the conductive seed material is applied to an end of the hydrophilic zone, and by capillary force leaves the conductive seeds throughout the hydrophilic zone.

36. The device of claim 34, further comprising a second conductive material applied to the conductive seeds to more fully define the conductive trace within the hydrophilic zone.

37. The device of claim 36, wherein the second conductive material is an electroless-plating conductive material applied via submersion of the hydrophilic zone within an electroless bath.

38. The device of claim 36, further comprising a third conductive material applied to the second conductive material to more fully define the conductive trace within the hydrophilic zone.

39. The device of claim 38, wherein the third conductive material is an electroplating conductive material applied to the second conductive material via electroplating.

40. The device of claim 29, further comprising an adhesive applied to the hydrophilic zone via wicking action, over the conductive material, the adhesive sealing the conductive material.

41. The device of claim 29, wherein the substrate is an inkjet printhead substrate, such that the device is an inkjet printhead.

42. A device comprising:
a substrate within which a wicking zone is defined as at least one of a groove and a through-hole; and,
means for defining a non-solder conductive trace within the wicking zone via an additive wicking process without subjection to a vacuum.

43. The device of claim 42, wherein the means is further for defining the conductive trace within the wicking zone via capillary force.

44. The device of claim 42, further comprising means for defining an adhesive sealant over the conductive trace within the wicking zone via an additive wicking process.

45. A device comprising:
a substrate within which a hydrophilic zone is defined;
a first conductive material applied to the hydrophilic zone via wicking action, to partially define a conductive trace within the hydrophilic zone by leaving seeds of the first conductive material throughout the hydrophilic zone; and,
a second conductive material applied to the seeds of the first conductive material to more fully define the conductive trace within the hydrophilic zone.

46. The device of claim 45, wherein the conductive seed material is applied to an end of the hydrophilic zone, and by capillary force leaves the seeds throughout the hydrophilic zone.

47. The device of claim 45, wherein the second conductive material is an electroless plating conductive material applied via submersion of the hydrophilic zone within an electroless bath.

48. The device of claim 45, further comprising a third conductive material applied to the second conductive material to more fully define the conductive trace within the hydrophilic zone.

49. The device of claim 48, wherein the third conductive material is an electroplating conductive material applied to the second conductive material via electroplating.

50. The device of claim 45, further comprising an adhesive applied to the hydrophilic zone via wicking action, over at least the first and second conductive materials, the adhesive sealing the conductive trace.

51. A device comprising:
a substrate within which a wicking zone is defined;
means for forming a plurality of conductive seeds throughout the wicking zone via an additive wicking process; and,
means for forming a conductive trace by application of a conductive material to the conductive seeds within the wicking zone.

52. The device of claim 51, further comprising means for defining an adhesive sealant over the conductive trace within the wicking zone via an additive wicking process.
